(19) United States
(12) Patent Application Publication
(10) Pub. No.: US 2021/0051954 A1
(43) Pub. Date: Feb. 25, 2021

(54) METHOD FOR INCREASING THE RESISTANCE OF A CEREAL PLANT

(71) Applicant: BASF AGROCHEMICAL PRODUCTS B.V., Arnhem (NL)

(72) Inventors: Jessica Rush, Mississauga (CA); Gabriel Sarmiento, Laguna (PH); Mitchell Stamm, Research Triangle Park, NC (US); Hector Alejandro Arevalo, Research Triangle Park, NC (US); Florent Mazuir, Limburgerhof (DE); Tatjana Sikuljak, Limburgerhof (DE)

(21) Appl. No.: 16/977,493

(22) PCT Filed: Mar. 6, 2019
(86) PCT No.: PCT/EP2019/055471

§ 371 Date: Sep. 2, 2020

(30) Foreign Application Priority Data
Mar. 7, 2018 (EP) 18160488.5

(51) Int. Cl. A01N 37/22

(52) U.S. Cl. CPC A01N 37/22

(57) ABSTRACT

The present invention relates to a method for increasing the resistance of a cereal plant selected from the group consisting of wheat and corn, and/or its plant propagation material to abiotic stress which method comprises treating the cereal plant selected from the group consisting of wheat and corn and/or its plant propagation material with at least one of i) compound of formula (Ia), ii) compound of formula (Ib), or formula (Ib) iii) mixture comprising a compound of formula (Ia) and a compound of formula (Ib); or an acceptable salt, stereoisomers, an isotopic form or N-oxide.

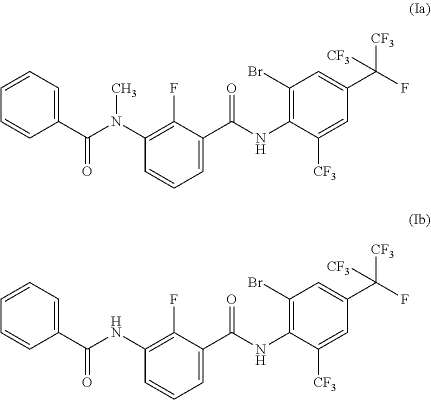 [SMILES: CN(C(=O)c1ccccc1)c1cccc(C(=O)Nc2c(Br)cc(C(F)(C(F)(F)F)C(F)(F)F)cc2C(F)(F)F)c1F ; O=C(Nc1cccc(C(=O)Nc2c(Br)cc(C(F)(C(F)(F)F)C(F)(F)F)cc2C(F)(F)F)c1F)c1ccccc1]

### FIELD OF THE INVENTION

The present invention relates to a method for increasing the resistance of a cereal plant selected from the group consisting of wheat and corn, and/or its plant propagation material to abiotic stress which method comprises treating the cereal plant selected from the group consisting of wheat and corn and/or its plant propagation material with at least one of
i) compound of formula (Ia),

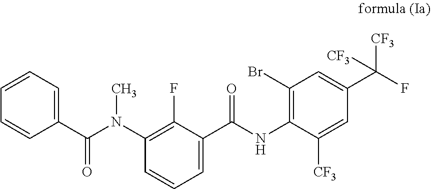 [SMILES: CN(C(=O)c1ccccc1)c1cccc(C(=O)Nc2c(Br)cc(C(F)(C(F)(F)F)C(F)(F)F)cc2C(F)(F)F)c1F]

ii) compound of formula (Ib), or

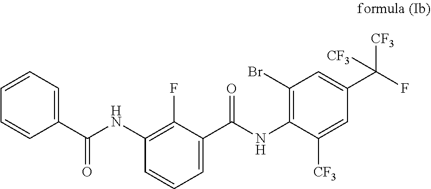 [SMILES: O=C(Nc1cccc(C(=O)Nc2c(Br)cc(C(F)(C(F)(F)F)C(F)(F)F)cc2C(F)(F)F)c1F)c1ccccc1]

iii) mixture comprising a compound of formula (Ia) and a compound of formula (Ib);
or an acceptable salt, stereoisomers, an isotopic form or N-oxide.

### DESCRIPTION OF THE INVENTION

The present invention relates to a method for increasing the resistance of a cereal plant selected from the group consisting of wheat and corn, and/or its plant propagation material to abiotic stress which method comprises treating the cereal plant selected from the group consisting of wheat and corn and/or its plant propagation material with at least one of
i) compound of formula (Ia),

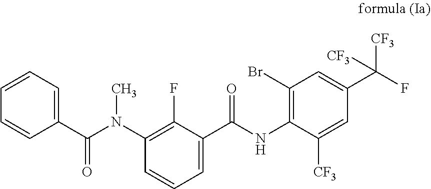 [SMILES: CN(C(=O)c1ccccc1)c1cccc(C(=O)Nc2c(Br)cc(C(F)(C(F)(F)F)C(F)(F)F)cc2C(F)(F)F)c1F]

ii) compound of formula (Ib), or

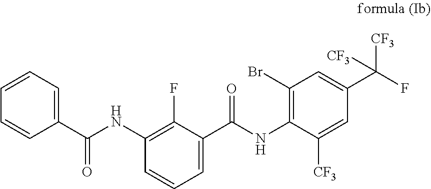 [SMILES: O=C(Nc1cccc(C(=O)Nc2c(Br)cc(C(F)(C(F)(F)F)C(F)(F)F)cc2C(F)(F)F)c1F)c1ccccc1]

iii) mixture comprising a compound of formula (Ia) and a compound of formula (Ib);
or an acceptable salt, stereoisomers, an isotopic form or N-oxide.

In addition, the present invention also relates to a method for increasing the resistance of a cereal plant selected from the group consisting of wheat and corn, wherein the increased resistance is determined by the increased rate of germination of cereal seed selected from the group consisting of wheat and corn and/or emergence and/or increasing the height of cereal plant selected from the group consisting of wheat and corn and/or increasing the root length of cereal plant selected from the group consisting of wheat and corn as compared to the cereal plant selected from the group consisting of wheat and corn and/or its plant propagation material not contacted with at least one of the compound of formula (Ia), (Ib) or mixture comprising the compound of formula (Ia) and the compound of formula (Ib), in various kinds of conditions as e.g. well-watered or drought conditions.

In one embodiment, the present invention relates to a method for increasing the resistance of a cereal plant selected from the group consisting of wheat and corn, wherein the increased resistance is determined by the increased rate of germination of cereal seed selected from the group consisting of wheat and corn.

According to the The Food and Agriculture Organization (FAO; 2004), population will continue to grow from currently 6.07 billion to 8.9 billion in 2050. Highest growth rates are expected in the developing countries. Obviously, the more people there are on Earth, the more resources are needed to meet their basic needs such as food and water. The United Nations Organization has pointed out that the food production has to nearly double to feed the expected global population. Even though there has been an impressive growth in food production during the last decades, which can mainly be attributed to the development of improved, disease-resistant varieties of staple crops and the increased use of chemical fertilizers and pesticides, the food production does not keep up with the rapid population growth. One of the most severe consequences is the expansion of arable land by cutting down forests or by irrigating cropland with salty water leading to salinization of the soils and widespread land degradation. Such inappropriate farming practices may impoverish and erode the soil; reduce vegetation and result in over-use and improperly use of agrochemicals. As a result, less arable and productive land is available. Taking climatic changes into account, it must additionally be expected that the yield will decline in many areas of the world due to adverse weather conditions. With respect to the growing world population, the increase of crop yield must be regarded as a global challenge.

Besides the growing world population which directly leads to an increased food and energy requirement, the growing wealth results in an increased meat consumption and consequently to an increase in feed demand. In addition, quality issues become more and more important. It is known that the food quality is regarded by many consumers as the most important parameter. Various parameters determine the food quality. Besides genetic aspects, the cropping system including the optimal nutrition as well as the protection against abiotic and biotic stress factors can alter the overall quality of plants and their products as an indicator of plant health to a substantial extent. Complying with the quality standards and at the same time to remain competitive at the market, ecologically sound and economically viable production methods are essential to the farmer.

WO 2016/162371 discloses that pesticidal carboxamide compound of formula (Ia), (Ib) or a mixture thereof are capable of increasing the plant health of a cultivated plant with at least one modification, for example herbicide tolerance, insect resistance and such, as compared to a respective non-modified control plant. However, this reference does not disclose the method as defined at the outset and its positive effects on the health of a plant such as for increasing the resistance of a cereal plant selected from the group consisting of wheat and corn, wherein the increased resistance is determined by the increased rate of germination of cereal seed selected from the group consisting of wheat and corn and/or emergence and/or increasing the height of cereal plant selected from the group consisting of wheat and corn and/or increasing the root length of cereal plant selected from the group consisting of wheat and corn as compared to the cereal plant selected from the group consisting of wheat and corn and/or its plant propagation material not contacted with at least one of the compound of formula (Ia), (Ib) or mixture comprising the compound of formula (Ia) and the compound of formula (Ib), in both well-watered and drought conditions.

In crop protection, there is a continuous need for methods that improve the health of plants. Healthier plants are desirable since they result among others in better yields and/or a better quality of the crop plants. Healthier plants also better resist to biotic and/or abiotic stress. A high resistance against abiotic stresses in turn allows the person skilled in the art to reduce the quantity of pesticides applied and consequently to slow down the development of resistances against the respective pesticides.

It has now been surprisingly found that this object is achieved by the method defined at the outset which provides enhanced plant health effects such as an increased geremination rate, increased root length and increased height.

In one embodiment, the method according to invention is a method to increase the resistance of a cereal plant selected from the group consisting of wheat and corn, and/or its plant propagation material to abiotic stress which method comprises treating the cereal plant selected from the group consisting of wheat and corn and/or its plant propagation material with at least one of
i) compound of formula (Ia),

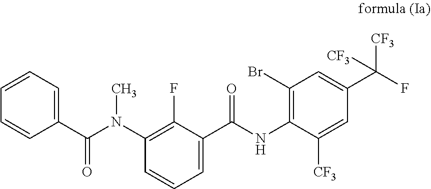 [SMILES: CN(C(=O)c1ccccc1)c1cccc(C(=O)Nc2c(Br)cc(C(F)(C(F)(F)F)C(F)(F)F)cc2C(F)(F)F)c1F]

ii) compound of formula (Ib), or

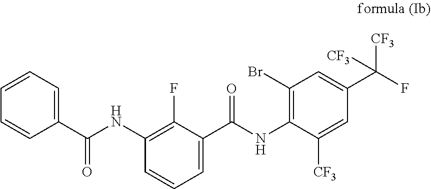 [SMILES: O=C(Nc1cccc(C(=O)Nc2c(Br)cc(C(F)(C(F)(F)F)C(F)(F)F)cc2C(F)(F)F)c1F)c1ccccc1]

iii) mixture comprising a compound of formula (Ia) and a compound of formula (Ib);
or an acceptable salt, stereoisomers, an isotopic form or N-oxide.

In one embodiment, the method according to invention comprises applying directly and/or indirectly to the cereal plant selected from the group consisting of wheat and corn and/or its plant propagation material by drenching the soil, by drip application onto the soil, by soil injection, by dipping or by treatment of seeds or in-furrow with a composition comprising at least one of compound of formula (Ia), (Ib) or mixture comprising the compound of formula (Ia) and the compound of formula (Ib) or an acceptable salt, stereoisomers, an isotopic form or N-oxide. More particularly, applying directly and/or indirectly to the cereal plant selected from the group consisting of wheat and corn and/or its plant propagation material by drenching the soil, a composition comprising at least one of compound of formula (Ia), (Ib) or mixture comprising the compound of formula (Ia) and the compound of formula (Ib) or an acceptable salt, stereoisomers, an isotopic form or N-oxide.

In one embodiment, the method according to invention comprises applying directly and/or indirectly to the cereal plant selected from the group consisting of wheat and corn the composition comprising at least one of compound of formula (Ia), (Ib) or mixture comprising the compound of formula (Ia) and the compound of formula (Ib) or an acceptable salt, stereoisomers, an isotopic form or N-oxide and/or a liquid or a solid carrier. In preferred embodiment, applying directly and/or indirectly to the cereal plant selected from the group consisting of wheat and corn the composition comprising compound of formula (Ia) or an acceptable salt, stereoisomers, an isotopic form or N-oxide and/or a liquid or a solid carrier.

One embodiment is the method according to the invention, wherein at least one of the compound of formula (Ia), (Ib) or mixture comprising the compound of formula (Ia) and the compound of formula (Ib) or an acceptable salt, stereoisomers, an isotopic form or N-oxide is applied once or multiple times.

Another embodiment of the invention is a method, when applying at least one of the compound of formula (Ia), (Ib) or mixture comprising the compound of formula (Ia) and the compound of formula (Ib) or an acceptable salt, stereoisomers, an isotopic form or N-oxide, the compounds are applied directly and/or indirectly to the cereal plant selected from the group consisting of wheat and corn and/or its plant propagation material. Preferably, the time interval for a subsequent application, ranges from a few seconds up to 3 months, preferably, from a few seconds up to 1 month, more preferably from a few seconds up to 2 weeks, even more preferably from a few seconds up to 3 days and in particular from 1 second up to 24 hours.

Another embodiment of the invention is a method, wherein the plant propagation material is seed.

Another embodiment of the invention is a method further comprises contacting a population of cereal seed selected from the group consisting of wheat and corn with at least one of compound of formula (Ia), (Ib) or mixture comprising the compound of formula (Ia) and the compound of formula (Ib) or an acceptable salt, stereoisomers, an isotopic form or N-oxide.

Another embodiment of the invention is a method, wherein the cereal plant and/or its plant propagation material is selected each in its natural or genetically modified form.

In one embodiment, the method according to the invention is a method to increase the resistance of a cereal plant selected from the group consisting of wheat and corn, and/or its plant propagation material to abiotic stress which method comprises treating the cereal plant selected from the group consisting of wheat and corn and/or its plant propagation material with at least one of
i) compound of formula (Ia),

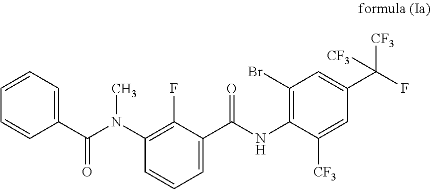 [SMILES: CN(C(=O)c1ccccc1)c1cccc(C(=O)Nc2c(Br)cc(C(F)(C(F)(F)F)C(F)(F)F)cc2C(F)(F)F)c1F]

ii) compound of formula (Ib), or

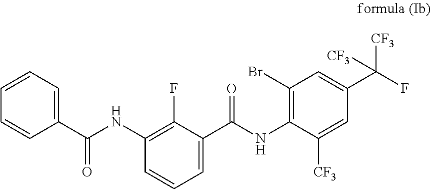 [SMILES: O=C(Nc1cccc(C(=O)Nc2c(Br)cc(C(F)(C(F)(F)F)C(F)(F)F)cc2C(F)(F)F)c1F)c1ccccc1]

iii) mixture comprising a compound of formula (Ia) and a compound of formula (Ib);
or an acceptable salt, stereoisomers, an isotopic form or N-oxide, wherein the increased resistance is determined by the increased rate of germination of cereal seed selected from the group consisting of wheat and corn and/or emergence and/or increasing the height of cereal plant selected from the group consisting of wheat and corn and/or increasing the root length of cereal plant selected from the group consisting of wheat and corn as compared to the cereal plant selected from the group consisting of wheat and corn and/or its plant propagation material not contacted with at least one of the compound of formula (Ia), (Ib) or mixture comprising the compound of formula (Ia) and the compound of formula (Ib) or an acceptable salt, stereoisomers, an isotopic form or N-oxide. In preferred embodiment, the increased resistance is determined by emergence and/or increasing the height of cereal plant selected from the group consisting of wheat and corn. In yet another preferred embodiment, the increaded resistance is determined by increasing the root length of cereal plant selected from the group consisting of wheat and corn.

In preferred embodiment, the increased resistance is determined by the increased rate of germination of cereal seed selected from the group consisting of wheat seed and corn seed.

In particular, the increased resistance is determined by the increased rate of germination of cereal seed of corn.

Another embodiment of the invention is a method wherein the increased resistance is determined by the increased drought resistance of the cereal plant selected from the group consisting of wheat and corn and/or its plant propagation material as compared to the the drought stress resistance of the cereal plant selected from the group consisting of wheat and corn and/or its plant propagation material not contacted with at least one of the compound of formula (Ia), (Ib) or mixture comprising the compound of formula (Ia) and the compound of formula (Ib) or an acceptable salt, stereoisomers, an isotopic form or N-oxide.

Another embodiment of the invention is a method wherein the increased resistance is determined by increased water uptake in the cereal plant selected from the group consisting of wheat and corn and/or its plant propagation material as compared to the water uptake of the cereal plant selected from the group consisting of wheat and corn and/or its plant propagation material not contacted with at least one of the compound of formula (Ia), (Ib) or mixture comprising the compound of formula (Ia) and the compound of formula (Ib) or an acceptable salt, stereoisomers, an isotopic form or N-oxide, in drought conditions.

Another embodiment of the invention is a method wherein the cereal plant selected from the group consisting of wheat and corn and/or its plant propagation material is in the crop production field.

Another embodiment of the invention is a method comprising applying directly and/or indirectly to the cereal plant selected from the group consisting of wheat and corn and/or its plant propagation an amount of from 0.0001 g to 100 g of at least one of the compound of formula (Ia), (Ib) or mixture comprising the compound of formula (Ia) and the compound of formula (Ib) or an acceptable salt, stereoisomers, an isotopic form or N-oxide, per plant. In particular, 0.0005 g to 50 g of at least one of the compound of formula (Ia), (Ib) or mixture comprising the compound of formula (Ia) and the compound of formula (Ib) or an acceptable salt, stereoisomers, an isotopic form or N-oxide, per plant. More particularly, 0.001 g to 50 g of at least one of the compound of formula (Ia), (Ib) or mixture comprising the compound of formula (Ia) and the compound of formula (Ib) or an acceptable salt, stereoisomers, an isotopic form or N-oxide, per plant.

Another embodiment of the invention is a method comprising treating the cereal seed selected from the group consisting of wheat and corn with an amount from 0.001 g to 100 g of at least one of the compound of formula (Ia), (Ib) or mixture comprising the compound of formula (Ia) and the compound of formula (Ib) or an acceptable salt, stereoisomers, an isotopic form or N-oxide, per 100 kg of seed. In particular, 0.01 g to 50 g of at least one of the compound of formula (Ia), (Ib) or mixture comprising the compound of formula (Ia) and the compound of formula (Ib) or an acceptable salt, stereoisomers, an isotopic form or N-oxide, per 100 kg of seed. More particularly, 5 g to 100 g of at least one of the compound of formula (Ia), (Ib) or mixture comprising the compound of formula (Ia) and the compound of formula (Ib) or an acceptable salt, stereoisomers, an isotopic form or N-oxide, per 100 kg of seed. In particular, 1 g to 50 g of at least one of the compound of formula (Ia), (Ib) or mixture comprising the compound of formula (Ia) and the compound of formula (Ib) or an acceptable salt, stereoisomers, an isotopic form or N-oxide, per 100 kg of seed.

Another embodiment of the invention is a method wherein the increased resistance of the cereal plant selected from the group consisting of wheat and corn and/or its plant propagation material is determined by improved yield as compared to the yield of the cereal plant selected from the group consisting of wheat and corn and/or its plant propagation material not contacted with at least one of the compound of formula (Ia), (Ib) or mixture comprising the compound of formula (Ia) and the compound of formula (Ib) or an acceptable salt, stereoisomers, an isotopic form or N-oxide.

Another embodiment of the invention is a method wherein the selected one or more increased resistance cereal plant selected from the group consisting of wheat and corn and/or its plant propagation material is further selected for having increased rate of germination of cereal seed selected from the group consisting of wheat and corn and/or emergence and/or increasing the height of cereal plant selected from the group consisting of wheat and corn and/or increasing the root length of cereal plant selected from the group consisting of wheat and corn and/or increased water uptake and/or increased drought resistance relative to cereal plant selected from the group consisting of wheat and corn and/or its plant propagation material not contacted with at least one of the compound of formula (Ia), (Ib) or mixture comprising the compound of formula (Ia) and the compound of formula (Ib) or an acceptable salt, stereoisomers, an isotopic form or N-oxide, in both well watered and drought conditions.

Another embodiment of the invention is a method wherein the selected one or more increased resistance cereal plant selected from the group consisting of wheat and corn and/or its plant propagation material is further selected for having improved yield under the drought conditions as compared to the yield of the cereal plant selected from the group consisting of wheat and corn and/or its plant propagation material not contacted with at least one of the compound of formula (Ia), (Ib) or mixture comprising the compound of formula (Ia) and the compound of formula (Ib) or an acceptable salt, stereoisomers, an isotopic form or N-oxide.

Preparation of the compound of formula (Ia) and (Ib) can be accomplished according to standard methods of organic chemistry, for example, by the methods or working examples described in WO 2010/018857 without being limited to the routes given therein.

The term “plant” is a synonym of the term “crop plant” which is to be understood as a plant of economic importance and/or a men-grown plant. The term “plant” as used herein includes all parts of a plant such as germinating seeds, emerging seedlings, herbaceous vegetation as well as established woody plants including all below ground portions (such as the roots) and aboveground portions. In one embodiment, the plant to be treated according to the method of the invention is an agricultural plant.

“Agricultural plants” are plants of which a part (e.g. seeds) or all is harvested or cultivated on a commercial scale or which serve as an important source of feed, food, fibres (e.g. cotton, linen), combustibles (e.g. wood, bioethanol, biodiesel, biomass) or other chemical compounds. Preferred agricultural plants are for example cereals, e.g. wheat, rye, barley, triticale, oats, sorghum or rice, beet, e.g. sugar beet or fodder beet; fruits, such as pomes, stone fruits or soft fruits, e.g. apples, pears, plums, peaches, almonds, cherries, strawberries, raspberries, blackberries or gooseberries; leguminous plants, such as lentils, peas, alfalfa or soybeans; oil plants, such as rape, oil-seed rape, canola, linseed, mustard, olives, sunflowers, coconut, cocoa beans, castor oil plants, oil palms, ground nuts or soybeans; cucurbits, such as squashes, cucumber or melons; fiber plants, such as cotton, flax, hemp or jute; citrus fruit, such as oranges, lemons, grapefruits or mandarins; vegetables, such as spinach, lettuce, asparagus, cabbages, carrots, onions, tomatoes, potatoes, cucurbits or paprika; lauraceous plants, such as avocados, cinnamon or camphor; energy and raw material plants, such as corn, soybean, rape, canola, sugar cane or oil palm; tobacco; nuts; coffee; tea; bananas; vines (table grapes and grape juice grape vines); hop; turf; natural rubber plants.

In one embodiment of the present invention, agricultural plants are field crops such as cereals e.g. wheat, rye, barley, triticale, oats, corn, sorghum or rice. In a preferred embodiment, the plant to be treated is a plant selected from wheat and corn.

In one embodiment of the present invention, agricultural plants are field crops such as soybeans.

The term “locus” is to be understood as any type of environment, soil, area or material where the plant is growing or is intended to grow as well as the environmental conditions (such as temperature, water availability, radiation) that have an influence on the growth and development of the plant and/or its propagules.

Watering cycles—The level of stress is created by watering the pots based on the % of pot moisture as measured by wireless probes. Depending on weather conditions the number of cycles vary as needed.

The % of moisture triggers the watering process independent of the time that it takes to reach this point.

In “well-watered conditions” or “standard watered conditions”, in the pots the % moisture is kept above 80%.

In “drought conditions”, in the pots re-watering happens at 45% pot moisture.

Soil Characterization:

| | Vermic- | Expanded | | | | Organic |
|---|---|---|---|---|---|---|
| | ulite | clay | Sand | Clay | Loam | matter |
| Mineral soil | 66.7% | 0 | 16.7% | 12.5% | 0 | 4.2% |
| Organic soil | 0 | 10% | 0 | 9% | 0 | 81% |

The term “genetically modified plants” is to be understood as plants, which genetic material has been modified by the use of recombinant DNA techniques in a way that under natural circumstances it cannot readily be obtained by cross breeding, mutations or natural recombination. The term “plant” is to be understood as including wild type plants and plants, which have been modified by either conventional breeding, or mutagenesis or genetic engineering, or by a combination thereof. Plants, which have been modified by mutagenesis or genetic engineering, and are of particular commercial importance, include alfalfa, rapeseed (e.g. oilseed rape), bean, carnation, chicory, cotton, eggplant, eucalyptus, flax, lentil, maize, melon, papaya, petunia, plum, poplar, potato, rice, soybean, squash, sugar beet, sugarcane, sunflower, sweet pepper, tobacco, tomato, and cereals (e.g. wheat), in particular maize, soybean, cotton, wheat, and rice. In plants, which have been modified by mutagenesis or genetic engineering, one or more genes have been mutagenized or integrated into the genetic material of the plant. The one or more mutagenized or integrated genes are preferably selected from pat, epsps, cry1Ab, bar, cry 1 Fa2, cry1Ac, cry34Ab1, cry35AB1, cry3A, cryF, cry IF, mcry3a, cry2Ab2, cry3Bb1, cry IA. 105, dfr, barnase, vip3Aa20, barstar, als, bxn, bp40, asnl, and pp05. The mutagenesis or integration of the one or more genes is performed in order to improve certain properties of the plant. Such properties, also known as traits, include abiotic stress tolerance, altered growth/yield, disease resistance, herbicide tolerance, insect resistance, modified product quality, and pollination control. Of these properties, herbicide tolerance, e.g. imidazolinone tolerance, glyphosate tolerance, or glufosinate tolerance, is of particular importance. Several plants have been rendered tolerant to herbicides by mutagenesis, for example Clearfield@ oilseed rape being tolerant to imidazolinones, e.g. imazamox. Alternatively, genetic engineering methods have been used to render plants, such as soybean, cotton, corn, beets and oil seed rape, tolerant to herbicides, such as glyphosate and glufosinate, some of which are commercially available under the trade names RoundupReady@ (glyphosate) and LibertyLink@ (glufosinate). Furthermore, insect resistance is of importance, in particular lepidopteran insect resistance and coleopteran insect resistance. Insect resistance is typically achieved by modifying plants by integrating cry and/or vip genes, which were isolated from Bacillus thuringiensis (Bt), and code for the respective Bt toxins. Genetically modified plants with insect resistance are commercially available under trade names including WideStrike@, Bollgard@, Agrisure@, Herculex@, YieldGard@, Genuity@, and Intacta@.

Plants may be modified by mutagenesis or genetic engineering either in terms of one property (singular traits) or in terms of a combination of properties (stacked traits). Stacked traits, e.g. the combination of herbicide tolerance and insect resistance, are of increasing importance. In general, all relevant modified plants in connection with singular or stacked traits as well as detailed 25 information as to the mutagenized or integrated genes and the respective events are available from websites of the organizations “International Service for the Acquisition of Agri-biotech Applications (ISAAA)” (http://www.isaaa.org/gmapprovaldatabase) and “Center for Environmental Risk Assessment (CERA)” (http://cera-gmc.org/GMCropDatabase).

“Transgenic plants” are those, which genetic material has been modified by the use of recombinant DNA techniques that under natural circumstances can not readily be obtained by cross breeding, mutations or natural recombination, whereby the modification confers a trait (or more than one trait) or confers the increase of a trait (or more than one trait) as listed below as compared to the wild-type plant. Preferably, the term “transgenic plant” refers to a plant, which has been modified by genetic engineering.

In one embodiment, one or more genes have been integrated into the genetic material of a genetically modified plant in order to improve certain properties of the plant, preferably increase a trait as listed below as compared to the wild-type plant. Such genetic modifications also include but are not limited to targeted post-translational modification of protein(s), or to post-transcriptional modifications of oligo- or polypeptides e.g. by glycosylation or polymer additions such as prenylated, acetylated, phosphorylated or farnesylated moieties or PEG moieties.

In one embodiment under the term “modification” when reffering to a transgenic plant or parts thereof is understood that the activity, expression level or amount of a gene product or the metabolite content is changed, e.g. increased or decreased, in a specific volume relative to a corresponding volume of a control, reference or wild-type plant or plant cell, including the de novo creation of the activity or expression.

In one embodiment, the activity of a polypeptide is increased or generated by expression or overexpresion of the gene coding for said polypeptide which confers a trait or confers the increase of a trait as listed below as compared to the control plant. The term “expression” or “gene expression” means the transcription of a specific gene or specific genes or specific genetic construct. The term “expression” or “gene expression” in particular means the transcription of a gene or genes or genetic construct into structural RNA (rRNA, tRNA), regulatory RNA (e.g. miRNA, RNAi, RNAa) or mRNA with or without subsequent translation of the latter into a protein. In another embodiment the term “expression” or “gene expression” in particular means the transcription of a gene or genes or genetic construct into structural RNA (rRNA, tRNA) or mRNA with or without subsequent translation of the latter into a protein. In yet another embodiment it means the transcription of a gene or genes or genetic construct into mRNA. The process includes transcription of DNA and processing of the resulting mRNA product. The term “increased expression” or “overexpression” as used herein means any form of expression that is additional to the original wild-type expression level.

The term “expression of a polypeptide” is understood in one embodiment to mean the level of said protein or polypeptide, preferably in an active form, in a cell or organism.

In one embodiment, the activity of a polypeptide is decreased by decreased expression of the gene coding for said polypeptide which confers a trait or confers the increase of a trait as listed below as compared to the control plant. Reference herein to “decreased expression” or “reduction or substantial elimination” of expression is taken to mean a decrease in endogenous gene expression and/or polypeptide levels and/or polypeptide activity relative to control plants. It comprises further reducing, repressing, decreasing or deleting of an expression product of a nucleic acid molecule.

The terms “reduction”, “repression”, “decrease” or “deletion” relate to a corresponding change of a property in an organism, a part of an organism such as a tissue, seed, root, tuber, fruit, leave, flower etc. or in a cell. Under “change of a property” it is understood that the activity, expression level or amount of a gene product or the metabolite content is changed in a specific volume or in a specific amount of protein relative to a corresponding volume or amount of protein of a control, reference or wild type. Preferably, the overall activity in the volume is reduced, decreased or deleted in cases if the reduction, decrease or deletion is related to the reduction, decrease or deletion of an activity of a gene product, independent whether the amount of gene product or the specific activity of the gene product or both is reduced, decreased or deleted or whether the amount, stability or translation efficacy of the nucleic acid sequence or gene encoding for the gene product is reduced, decreased or deleted.

The terms “reduction”, “repression”, ‘decrease” or ‘deletion” include the change of said property in only parts of the subject of the present invention, for example, the modification can be found in compartment of a cell, like an organelle, or in a part of a plant, like tissue, seed, root, leave, tuber, fruit, flower etc. but is not detectable if the overall subject, i.e. complete cell or plant, is tested. Preferably, the “reduction”, “repression”, “decrease” or “deletion” is found cellular, thus the term “reduction, decrease or deletion of an activity” or “reduction, decrease or deletion of a metabolite content” relates to the cellular reduction, decrease or deletion compared to the wild type cell. In addition, the terms “reduction”, “repression”, “decrease” or “deletion” include the change of said property only during different growth phases of the organism used in the inventive process, for example the reduction, repression, decrease or deletion takes place only during the seed growth or during blooming. Furthermore, the terms include a transitional reduction, decrease or deletion for example because the used method, e.g. the antisense, RNAi, snRNA, dsRNA, siRNA, miRNA, tasiRNA, cosuppression molecule, or ribozyme, is not stable integrated in the genome of the organism or the reduction, decrease, repression or deletion is under control of a regulatory or inducible element, e.g. a chemical or otherwise inducible pro20 moter, and has therefore only a transient effect.

Methods to achieve said reduction, decrease or deletion in an expression product are known in the art, for example from the international patent application WO 2008/034648, particularly in paragraphs [0020.1.1.1], [0040.1.1.1], [0040.2.1.1] and [0041.1.1.1].

Reducing, repressing, decreasing or deleting of an expression product of a nucleic acid mole25 cule in modified plants is known. Examples are canola i.e. double nill oilseed rape with reduced amounts of erucic acid and sinapins.

Such a decrease can also be achieved for example by the use of recombinant DNA technology, such as antisense or regulatory RNA (e.g. miRNA, RNAi, RNAa) or siRNA approaches. In particular RNAi, snRNA, dsRNA, siRNA, miRNA, ta-siRNA, cosuppression molecule, ribozyme, or antisense nucleic acid molecule, a nucleic acid molecule conferring the expression of a dominant-negative mutant of a protein or a nucleic acid construct capable to recombine with and silence, inactivate, repress or reduces the activity of an endogenous gene may be used to decrease the activity of a polypeptide in a transgenic plant or parts thereof or a plant cell thereof used in one embodiment of the methods of the invention. Examples of transgenic plants with reduced, repressed, decreased or deleted expression product of a nucleic acid molecule are Carica papaya (Papaya plants) with the event name XI 7-2 of the University of Florida, Prunus domestica (Plum) with the event name C5 of the United States Department of Agriculture—Agricultural Research Service. Also known are plants with increased resistance to nematodes for example by reducing, repressing, decreasing or deleting of an expression product of a nucleic acid molecule, e.g. from the PCT publication WO 2008/095886.

The reduction or substantial elimination is in increasing order of preference at least 10%, 20%, 30%, or 50%, 60%, 70%, 80%, 85%, 90%, or 95%, 96%, 97%, 98%, or more reduced compared to that of control plants. Reference herein to an “endogenous” gene not only refers to the gene in question as found in a plant in its natural form (i.e., without there being any human intervention), but also refers to that same gene (or a substantially homologous nucleic acid/gene) in an isolated form subsequently (re)introduced into a plant (a transgene). For example, a transgenic plant containing such a transgene may encounter a substantial reduction of the transgene expression and/or substantial reduction of expression of the endogenous gene.

The terms “control” or “reference” are exchangeable and can be a cell or a part of a plant such as an organelle like a chloroplast or a tissue, in particular a plant, which was not modified or treated according to the herein described process according to the invention. Accordingly, the plant used as control or reference corresponds to the plant as much as possible and is as identical to the subject matter of the invention as possible. Thus, the control or reference is treated identically or as identical as possible, saying that only conditions or properties might be different which do not influence the quality of the tested property other than the treatment of the present invention.

It is possible that control or reference plants are wild-type plants. However, “control” or “reference” may refer to plants carrying at least one genetic modification, when the plants employed in the process of the present invention carry at least one genetic modification more than said control or reference plants. In one embodiment control or reference plants may be transgenic but differ from transgenic plants employed in the process of the present invention only by said modification contained in the transgenic plants employed in the process of the present invention.

The term “wild type” or “wild-type plants” refers to a plant without said genetic modification.

These terms can refer to a cell or a part of a plant such as an organelle like a chloroplast or a tissue, in particular a plant, which lacks said genetic modification but is otherwise as identical as possible to the plants with at least one genetic modification employed in the present invention.

In a particular embodiment, the “wild-type” plant is not transgenic.

Preferably, the wild type is identically treated according to the herein described process according to the invention. The person skilled in the art will recognize if wild-type plants will not require certain treatments in advance to the process of the present invention, e.g. nontransgenic wild-type plants will not need selection for transgenic plants for example by treatment with a selecting agent such as a herbicide.

The control plant may also be a nullizygote of the plant to be assessed. The term “nullizygotes” refers to a plant that has undergone the same production process as a transgenic, yet has lost the once aquired genetic modification (e.g. due to mendelian segregation) as the corresponding transgenic. If the starting material of said production process is transgenic, then nullizygotes are also transgenic but lack the additional genetic modification introduced by the production process. In the process of the present invention the purpose of wild-type and nullizygotes is the same as the one for control and reference or parts thereof. All of these serve as controls in any comparison to provide evidence of the advantageous effect of the present invention.

Preferably, any comparison is carried out under analogous conditions. The term “analogous conditions” means that all conditions such as, for example, culture or growing conditions, soil, nutrient, water content of the soil, temperature, humidity or surrounding air or soil, assay conditions (such as buffer composition, temperature, substrates, pathogen strain, concentrations and the like) are kept identical between the experiments to be compared. The person skilled in the art will recognize if wild-type, control or reference plants will not require certain treatments in advance to the process of the present invention, e.g. nontransgenic wild-type plants will not need selection for transgenic plants for example by treatment with herbicide.

In case that the conditions are not analogous the results can be normalized or standardized based on the control.

The “reference”, “control”, or “wild type” is preferably a plant, which was not modified or treated according to the herein described process of the invention and is in any other property as similar to a plant, employed in the process of the present invention of the invention as possible. The reference, control or wild type is in its genome, transcriptome, proteome or metabolome as similar as possible to a plant, employed in the process of the present invention of the present invention. Preferably, the term “reference-” ‘control-” or “wild-type-” plant, relates to a plant, which is nearly genetically identical to the organelle, cell, tissue or organism, in particular plant, of the present invention or a part thereof preferably 90% or more, e.g. 95%, more preferred are 98%, even more preferred are 99.00%, in particular 99.10%, 99.30%, 99.50%, 99.70%, 99.90%, 99.99%, 99.999% or more. Most preferable the “reference”, “control”, or “wild type” is a plant, which is genetically identical to the plant, cell, a tissue or organelle used according to the process of the invention except that the responsible or activity conferring nucleic acid molecules or the gene product encoded by them have been amended, manipulated, exchanged or introduced in the organelle, cell, tissue, plant, employed in the process of the present invention. Preferably, the reference and the subject matter of the invention are compared after standardization and normalization, e.g. to the amount of total RNA, DNA, or protein or activity or expression of reference genes, like housekeeping genes, such as ubiquitin, actin or ribosomal proteins.

The genetic modification carried in the organelle, cell, tissue, in particular plant used in the process of the present invention is in one embodiment stable e.g. due to a stable transgenic integration or to a stable mutation in the corresponding endogenous gene or to a modulation of the expression or of the behaviour of a gene, or transient, e.g. due to an transient transformation or temporary addition of a modulator such as an agonist or antagonist or inducible, e.g. after transformation with a inducible construct carrying a nucleic acid molecule under control of a inducible promoter and adding the inducer, e.g. tetracycline.

The “modified plants” and/or “transgenic plants” are be selected from the group consisting of cereals, such as maize (corn), wheat, barley sorghum, rice, rye, millet, triticale, oat, pseudocereals (such as buckwheat and quinoa), alfalfa, apples, banana, beet, broccoli, Brussels sprouts, cabbage, canola (rapeseed), carrot, cauliflower, cherries, chickpea, Chinese cabbage, Chinese mustard, collard, cotton, cranberries, creeping bentgrass, cucumber, eggplant, flax, grape, grapefruit, kale, kiwi, kohlrabi, melon, mizuna, mustard, papaya, peanut, pears, pepper, persimmons, pigeonpea, pineapple, plum, potato, raspberry, rutabaga, soybean, squash, strawberries, sugar beet, sugarcane, sunflower, sweet corn, tobacco, tomato, turnip, walnut, watermelon and winter squash, more preferably from the group consisting of alfalfa, canola (rapeseed), cotton, rice, maize, cerals (such as wheat, barley, rye, oat), soybean, fruits and vegetables (such as potato, tomato, melon, papaya), pome fruits (such as apple and pear), vine, sugarbeet, sugarcane, rape, citrus fruits (such as citron, lime, orange, pomelo, grapefruit, and mandarin) and stone fruits (such as cherry, apricot and peach), most preferably from cotton, rice, maize, cerals (such as wheat, barley, rye, oat), sorghum, squash, soybean, potato, vine, pome fruits (such as apple), citrus fruits (such as citron and orange), sugarbeet, sugarcane, rape, oilseed rape and tomatoes, utmost preferably from cotton, rice, maize, wheat, barley, rye, oat, soybean, potato, vine, apple, pear, citron and orange.

In one embodiment of the invention, “modified plants” and/or “transgenic plants” are be selected from the group consisting of cereals, such as maize, corn, wheat, barley sorghum, rice, rye, millet, triticale, oat, pseudocereals (such as buckwheat and quinoa).

In another embodiment, from the group consisting of cereals, such corn and wheat.

In one embodiment of the invention, “modified plants” and/or “transgenic plants” is soybean.

The term “plant propagation material” is to be understood to denote all the generative parts of the plant such as seeds and vegetative plant material such as cuttings and tubers (e.g. potatoes), which can be used for the multiplication of the plant. This includes seeds, grains, roots, fruits, tubers, bulbs, rhizomes, cuttings, spores, offshoots, shoots, sprouts and other parts of plants, including seedlings and young plants, which are to be transplanted after germination or after emergence from soil, meristem tissues, single and multiple plant cells and any other plant tissue from which a complete plant can be obtained.

The term “propagules” or “plant propagules” is to be understood to denote any structure with the capacity to give rise to a new plant, e.g. a seed, a spore, or a part of the vegetative body capable of independent growth if detached from the parent. In a preferred embodiment, the term “propagules” or “plant propagules” denotes for seed.

The term “BBCH principal growth stage” refers to the extended BBCH-scale which is a system for a uniform coding of phenologically similar growth stages of all mono- and dicotyledonous plant species in which the entire developmental cycle of the plants is subdivided into clearly recognizable and distinguishable longer-lasting developmental phases. The BBCH-scale uses a decimal code system, which is divided into principal and secondary growth stages. The abbreviation BBCH derives from “Biologische Bundesanstalt, Bundessortenamt and CHemische Industrie” (the Federal Biological Research Centre for Agriculture and Forestry (Germany), the Bundessortenamt (Germany) and the chemical industry).

The term “vegetative growth stage” is to be understood to denote the BBCH principal growth stages 1 (leaf development), 2 (formation of side shoots; tillering), 3 (stem elongation or rosette growth, shoot development) and 4 (development of harvestable vegetative plant parts or vegetatively propagated organs).

The term “reproductive growth stage” is to be understood to denote the BBCH principal growth stages 5 (inflorescence emergence; heading), 6 (flowering) and 7 (development of fruit).

The term “synergistically’ means that the purely additive (in mathematical terms) plant health increasing effects of a simultaneous, that is joint or separate application of the compounds according to the invention, or successive application of the compounds according to the invention is surpassed by the application the respective compounds according to the method of the invention.

The term “health of a plant” or “plant health” is defined as a condition of the plant and/or its products. As a result of the improved health, yield, plant vigor, quality and tolerance to abiotic or biotic stress are increased. Noteworthy, the health of a plant when applying the method according to the invention, is increased independently of the pesticidal properties of the active ingredients used because the increase in health is not based upon the reduced pest pressure but instead on complex physiological and metabolic reactions which result for example in an activation of the plant's own natural defense system. As a result, the health of a plant is increased even in the absence of pest pressure.

Accordingly, in an especially preferred embodiment of the method according to the invention, the health of a plant is increased both in the presence and absence of biotic or abiotic stress factors.

The above identified indicators for the health condition of a plant may be interdependent or they may result from each other. An increase in plant vigor may for example result in an increased yield and/or tolerance and/or resistance to abiotic or biotic stress.

One indicator for the condition of the plant is the yield. “Yield” is to be understood as any plant product of economic value that is produced by the plant such as grains, fruits in the proper sense, vegetables, nuts, grains, seeds, wood (e.g. in the case of silviculture plants) or even flowers (e.g. in the case of gardening plants, ornamentals). The plant products may in addition be further utilized and/or processed after harvesting. In particular, the yield of the treated plant is increased. More particularly, the yield of the plants treated according to the method of the invention, is increased synergistically.

In one embodiment, “increased yield” of a plant, in particular of an agricultural, silvicultural and/or horticultural plant means that the yield of a product of the respective plant is increased by a measurable amount over the yield of the same product of the plant produced under the same conditions, but without the application of the mixture according to the invention.

In particular, increased yield can be characterized, among others, by the following improved properties of the plant:
increased plant weight
increased plant height
increased biomass such as higher overall fresh weight (FW)
increased number of flowers per plant
higher grain yield
more tillers or side shoots (branches)
larger leaves
increased shoot growth
increased protein content
increased oil content
increased starch content
increased pigment content
increased leaf index

In particular, the yield is increased by at least 4%, preferable by 5 to 10%, more preferable by 10 to 20%, or even 20 to 30% compared to the untreated control plants or plants treated with pesticides in a way different from the method according to the present invention. In general, the yield increase may even be higher.

A further indicator for the condition of the plant is the plant vigor. The plant vigor becomes manifest in several aspects such as the general visual appearance. In particular, the plant vigor of the treated plant is increased. More particularly, the plant vigor of the plants treated according to the method of the invention, is increased synergistically.

Improved plant vigor can be characterized, among others, by the following improved properties of the plant:
improved vitality of the plant
improved plant growth
improved plant development
improved visual appearance
improved plant stand (less plant verse/lodging)
improved emergence
enhanced root growth and/or more developed root system
enhanced nodulation, in particular rhizobial nodulation
bigger leaf blade
bigger size
increased plant weight
increased plant height
increased tiller number
increased number of side shoots
increased number of flowers per plant
increased shoot growth
increased root growth (extensive root system)
increased yield when grown on poor soils or unfavorable climate
enhanced photosynthetic activity (e.g. based on increased stomatal conductance and/or increased CO2 assimilation rate)
increased stomatal conductance
increased CO2 assimilation rate
enhanced pigment content (e.g. chlorophyll content)
earlier flowering
earlier fruiting
earlier and improved germination
earlier grain maturity
improved self-defence mechanisms
improved stress tolerance and resistance of the plants against biotic and abiotic stress factors such as fungi, bacteria, viruses, insects, heat stress, cold stress, drought stress, UV stress and/or salt stress
less non-productive tillers
less dead basal leaves
less input needed (such as fertilizers or water)
greener leaves
complete maturation under shortened vegetation periods
less fertilizers needed
less seeds needed
easier harvesting
faster and more uniform ripening longer shelf-life longer panicles
delay of senescence
stronger and/or more productive tillers
better extractability of ingredients
improved quality of seeds (for being seeded in the following seasons for seed production)
better nitrogen uptake
improved reproduction
reduced production of ethylene and/or the inhibition of its reception by the plant.

The improvement of the plant vigor particularly means that the improvement of any one or several or all of the above-mentioned plant characteristics are improved independently of the pesticidal action of the mixture or active ingredients (components).

Another indicator for the condition of the plant is the “quality” of a plant and/or its products.

In one embodiment of the invention, the quality of the treated plant is increased.

In one embodiment of the invention, the quality of the plants treated according to the method of the invention, is increased synergistically. In particular, enhanced quality means that certain plant characteristics such as the content or composition of certain ingredients are increased or improved by a measurable or noticeable amount over the same factor of the plant produced under the same conditions, but without the application of the mixtures of the present invention. Enhanced quality can be characterized, among others, by following improved properties of the plant or its product:
increased nutrient content
increased protein content
increased content of fatty acids
increased metabolite content
increased carotenoid content
increased sugar content
increased amount of essential amino acids
improved nutrient composition
improved protein composition
improved composition of fatty acids
improved metabolite composition
improved carotenoid composition
improved sugar composition
improved amino acids composition
improved or optimal fruit color
improved leaf color
higher storage capacity
higher processability of the harvested products.

Another indicator for the condition of the plant is the plant's tolerance or resistance to biotic and/or abiotic stress factors. Biotic and abiotic stress, especially over longer terms, can have harmful effects on plants. Biotic stress is caused by living organisms while abiotic stress is caused for example by environmental extremes.

In one embodiment of the present invention, “enhanced tolerance or resistance to biotic and/or abiotic stress factors” means
(1) that certain negative factors caused by biotic and/or abiotic stress are diminished in a measurable or noticeable amount as compared to plants exposed to the same conditions, but without being treated with a mixture according to the invention and
(2) that the negative effects are not diminished by a direct action of the mixture according to the invention on the stress factors, e.g. by its fungicidal or insecticidal action which directly destroys the microorganisms or pests, but rather by a stimulation of the plants' own defensive reactions against said stress factors.

In one preferred embodiment of the invention, the tolerance or resistance to abiotic stress of the treated plant is increased. In particular, the tolerance or resistance to abiotic stress of the plants treated according to the method of the invention, is increased synergistically.

Negative factors caused by abiotic stress are also well-known and can often be observed as reduced plant vigor (see above), for example: dotted leaves, “burned leaves”, reduced growth, less flowers, less biomass, less crop yields, reduced nutritional value of the crops, later crop maturity, to give just a few examples. Abiotic stress can be caused for example by:
extremes in temperature such as heat or cold (heat stress/cold stress)
strong variations in temperature
temperatures unusual for the specific season
drought (drought stress)
extreme wetness
high salinity (salt stress)
radiation (for example by increased UV radiation due to the decreasing ozone layer)
increased ozone levels (ozone stress)
organic pollution (for example by phythotoxic amounts of pesticides)
inorganic pollution (for example by heavy metal contaminants).

As a result of biotic and/or abiotic stress factors, the quantity and the quality of the stressed plants, their crops and fruits decrease. As far as quality is concerned, reproductive development is usually severely affected with consequences on the crops which are important for fruits or seeds. Synthesis, accumulation and storage of proteins are mostly affected by temperature; growth is slowed by almost all types of stress; polysaccharide synthesis, both structural and storage is reduced or modified: these effects result in a decrease in biomass (yield) and in changes in the nutritional value of the product.

Advantageous properties, obtained especially from treated seeds, are e.g. improved germination and field establishment, better vigor and/or a more homogen field establishment.

As pointed out above, the above identified indicators for the health condition of a plant may be interdependent and may result from each other. For example, an increased resistance to abiotic stress may lead to a better plant vigor, e.g. to better and bigger crops, and thus to an increased yield. Inversely, a more developed root system may result in an increased resistance to abiotic stress. However, these interdependencies and interactions are neither all known nor fully understood and therefore the different indicators are described separately. In particular, the use of the comprising the compound of formula (Ia) and the compound of formula (Ib) within the methods according to the invention results in an increased yield of a plant or its product. In particular, the use of the mixtures within the methods according to the invention results in an increased vigor of a plant or its product.

In particular, the use of the mixtures within the methods according to the invention results in an increased quality of a plant or its product.

In one embodiment, the use of the comprising the compound of formula (Ia) and the compound of formula (Ib) within the methods according to the invention results in an increased tolerance and/or resistance of a plant or its product against abiotic stress.

In an analogous way as described above for cereals, all the embodiments of the methods of the present invention can be performed on soybean.

In another embodiment, the method for increasing the resistance of a soybean plant and/or its plant propagation material to abiotic stress which method comprises treating the soybean plant and/or its plant propagation material with at least one of
i) compound of formula (Ia),

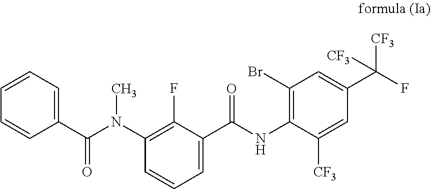 [SMILES: CN(C(=O)c1ccccc1)c1cccc(C(=O)Nc2c(Br)cc(C(F)(C(F)(F)F)C(F)(F)F)cc2C(F)(F)F)c1F]

ii) compound of formula (Ib), or

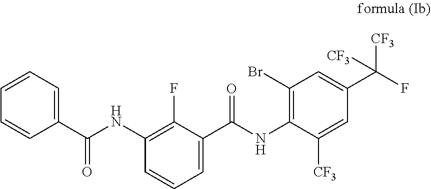 [SMILES: O=C(Nc1cccc(C(=O)Nc2c(Br)cc(C(F)(C(F)(F)F)C(F)(F)F)cc2C(F)(F)F)c1F)c1ccccc1]

iii) mixture comprising a compound of formula (Ia) and a compound of formula (Ib), or an acceptable salt, stereoisomers, an isotopic form or N-oxide.
In another embodiment, the method of present invention comprises applying directly and/or indirectly to the soybean plant and/or its plant propagation material by drenching the soil, by drip application onto the soil, by soil injection, by dipping or by treatment of seeds or in-furrow, a composition comprising at least one of compound of formula (Ia), (Ib) or mixture comprising the compound of formula (Ia) and the compound of formula (Ib) or an acceptable salt, stereoisomers, an isotopic form or N-oxide.

Formulations

In the following, suitable formulations and applications in connection with the present application are disclosed. These preferred embodiments relate (1) method for increasing the resistance of a cereal plant selected from the group consisting of wheat and corn, and/or its plant propagation material to abiotic stress which method comprises treating the cereal plant selected from the group consisting of wheat and corn and/or its plant propagation material with at least one of of compound of formula (Ia), (Ib) or mixture comprising the compound of formula (Ia) and the compound of formula (Ib) and (2) method of increasing the resistance of the present invention comprising applying directly and/or indirectly to the cereal plant selected from the group consisting of wheat and corn and/or its plant propagation material by drenching the soil, by drip application onto the soil, by soil injection, by dipping or by treatment of seeds or in-furrow with a composition comprising at least one of compound of formula (Ia), (Ib) or mixture comprising the compound of formula (Ia) and the compound of formula (Ib).

When it is in the following referred to “the compound of formula (Ia)”, “the compound of formula (Ib)” to “the compound of the present invention” to “the mixture of the invention”, or “the mixture comprising the compound of formula (Ia) and the compound of formula (Ib)” it is to be understood that the embodiments are disclosed in combination with (1) the method of the invention and (2) method of the invention comprising the application of the composition comprising at least one of compound of formula (Ia), (Ib) or mixture comprising the compound of formula (Ia) and the compound of formula (Ib). In particular, at least one of compound of formula (Ia), (Ib) or mixture comprising the compound of formula (Ia) and the compound of formula (Ib) may be provided in the form of an agrochemical composition comprising at least one of compound of formula (Ia), (Ib) or mixture comprising the compound of formula (Ia) and the compound of formula (Ib) optionally together with one or more other pesticidal active ingredient(s) and an auxiliary. More particularly, at least one of compound of formula (Ia), (Ib) or mixture comprising the compound of formula (Ia) and the compound of formula (Ib) may be provided in the form of an agrochemical composition comprising a pesticidally effective amount of at least one of compound of formula (Ia), (Ib) or mixture comprising the compound of formula (Ia) and the compound of formula (Ib) optionally together with one or more other pesticidal active ingredient(s) and an auxiliary.

The term “pesticidally effective amount” is defined below.

The formulations comprising at least one of compound of formula (Ia), (Ib) or mixture comprising the compound of formula (Ia) and the compound of formula (Ib) of the present invention can be converted into customary types of agrochemical compositions, e. g. solutions, emulsions, suspensions, dusts, powders, pastes, granules, pressings, capsules, and mixtures thereof. Examples for composition types are suspensions (e.g. SC, OD, FS), emulsifiable concentrates (e.g. EC), emulsions (e.g. EW, EO, ES, ME), capsules (e.g. CS, ZC), pastes, pastilles, wettable powders or dusts (e.g. WP, SP, WS, DP, DS), pressings (e.g. BR, T B, DT), granules (e.g. WG, SG, GR, FG, GG, MG), insecticidal articles (e.g. LN), as well as gel formulations for the treatment of plant propagation materials such as seeds (e.g. GF). These and further compositions types are defined in the “Catalogue of pesticide formulation types and international coding system”, Technical Mono-graph No. 2, 6th Ed. May 2008, CropLife International.

The compositions are prepared in a known manner, such as described by Mollet and Grubemann, Formulation technology, Wiley VCH, Weinheim, 2001; or Knowles, New developments in 30 crop protection product formulation, Agrow Reports DS243, T&F Informa, London, 2005.

Examples for suitable auxiliaries are solvents, liquid carriers, solid carriers or fillers, surfactants, dispersants, emulsifiers, wetters, adjuvants, solubilizers, penetration enhancers, protective colloids, adhesion agents, thickeners, humectants, repellents, attractants, feeding stimulants, compatibilizers, bactericides, anti-freezing agents, anti-foaming agents, colorants, tackifiers and binders.

Suitable solvents and liquid carriers are water and organic solvents, such as mineral oil fractions of medium to high boiling point, e.g. kerosene, diesel oil; oils of vegetable or animal origin; aliphatic, cyclic and aromatic hydrocarbons, e. g. toluene, paraffin, tetrahydronaphthalene, alkylated naphthalenes; alcohols, e.g. ethanol, propanol, butanol, benzylalcohol, cyclohexanol; glycols; DMSO; ketones, e.g. cyclohexanone; esters, e.g. lactates, carbonates, fatty acid esters, gamma-butyrolactone; fatty acids; phosphonates; amines; amides, e.g. N-methylpyrrolidone, fatty acid dimethylamides; and mixtures thereof.

Suitable solid carriers or fillers are mineral earths, e.g. silicates, silica gels, talc, kaolins, limestone, lime, chalk, clays, dolomite, diatomaceous earth, bentonite, calcium sulfate, magnesium sulfate, magnesium oxide; polysaccharide powders, e.g. cellulose, starch; fertilizers, e.g. ammonium sulfate, ammonium phosphate, ammonium nitrate, ureas; products of vegetable origin, e.g. cereal meal, tree bark meal, wood meal, nutshell meal, and mixtures thereof.

Suitable surfactants are surface-active compounds, such as anionic, cationic, nonionic and amphoteric surfactants, block polymers, polyelectrolytes, and mixtures thereof. Such surfactants can be used as emusifier, dispersant, solubilizer, wetter, penetration enhancer, protective colloid, or adjuvant. Examples of surfactants are listed in McCutcheon's, Vol. 1: Emulsifiers & Detergents, McCutcheon's Directories, Glen Rock, USA, 2008 (International Ed. or North American Ed.).

Suitable anionic surfactants are alkali, alkaline earth or ammonium salts of sulfonates, sulfates, phosphates, carboxylates, and mixtures thereof. Examples of sulfonates are alkylarylsulfonates, diphenylsulfonates, alpha-olefin sulfonates, lignine sulfonates, sulfonates of fatty acids and oils, sulfonates of ethoxylated alkylphenols, sulfonates of alkoxylated arylphenols, sulfonates of condensed naphthalenes, sulfonates of dodecyl- and tridecylbenzenes, sulfonates of naphthalenes and alkyl a naphthalenes, sulfosuccinates or sulfosuccinamates. Examples of sulfates are sulfates of fatty acids and oils, of ethoxylated alkylphenols, of alcohols, of ethox-ylated alcohols, or of fatty acid esters. Examples of phosphates are phosphate esters. Exam-pies of carboxylates are alkyl carboxylates, and carboxylated alcohol or alkylphenol ethoxylates.

Suitable nonionic surfactants are alkoxylates, N-subsituted fatty acid amides, amine oxides, esters, sugar-based surfactants, polymeric surfactants, and mixtures thereof. Examples of alkoxylates are compounds such as alcohols, alkylphenols, amines, amides, arylphenols, fatty acids or fatty acid esters which have been alkoxylated with 1 to 50 equivalents. Ethylene oxide and/or propylene oxide may be employed for the alkoxylation, preferably ethylene oxide. Examples of N-subsititued fatty acid amides are fatty acid glucamides or fatty acid alkanolamides. Examples of esters are fatty acid esters, glycerol esters or monoglycerides. Examples of sugarbased surfactants are sorbitans, ethoxylated sorbitans, sucrose and glucose esters or alkylpolyglucosides. Examples of polymeric surfactants are homo- or copolymers of vinylpyrrolidone, vinylalcohols, or vinylacetate.

Suitable cationic surfactants are quaternary surfactants, for example quaternary ammonium compounds with one or two hydrophobic groups, or salts of long-chain primary amines. Suitable amphoteric surfactants are alkylbetains and imidazolines. Suitable block polymers are block polymers of the A-B or A-B-A type comprising blocks of polyethylene oxide and polypropylene oxide, or of the A-B-C type comprising alkanol, polyethylene oxide and polypropylene oxide. Suitable polyelectrolytes are polyacids or polybases. Examples of polyacids are alkali salts of polyacrylic acid or polyacid comb polymers. Examples of polybases are polyvinylamines or polyethyleneamines.

Suitable adjuvants are compounds, which have a neglectable or even no pesticidal activity themselves, and which improve the biological performance of the ative ingredients(s) on the target. Examples are surfactants, mineral or vegetable oils, and other auxilaries. Further examples are listed by Knowles, Adjuvants and additives, Agrow Reports DS256, T&F Informa UK, 2006, chapter 5.

Suitable thickeners are polysaccharides (e.g. xanthan gum, carboxymethylcellulose), anorganic clays (organically modified or unmodified), polycarboxylates, and silicates.

Suitable bactericides are bronopol and isothiazolinone derivatives such as alkylisothiazolinones and benzisothiazolinones.

Suitable anti-freezing agents are ethylene glycol, propylene glycol, urea and glycerin.

Suitable anti-foaming agents are silicones, long chain alcohols, and salts of fatty acids.

Suitable colorants (e.g. in red, blue, or green) are pigments of low water solubility and watersoluble dyes. Examples are inorganic colorants (e.g. iron oxide, titan oxide, iron hexacyanoferrate) and organic colorants (e.g. alizarin-, azo- and phthalocyanine colorants).

Suitable tackifiers or binders are polyvinylpyrrolidons, polyvinylacetates, polyvinyl alcohols, polyacrylates, biological or synthetic waxes, and cellulose ethers. Examples for composition types and their preparation are:

i) Water-Soluble Concentrates (SL, LS)

10-60 wt % of the pesticidal active compound(s), and 5-15 wt % wetting agent (e.g. alcohol alkoxylates) are dissolved in water and/or in a water-soluble solvent (e.g. alcohols) up to 100 wt %. The active substance dissolves upon dilution with water.

ii) Dispersible Concentrates (DC)

5-25 wt % of the pesticidal active compound(s), and 1-10 wt % dispersant (e. g. polyvinylpyrrolidone) are dissolved in up to 100 wt % organic solvent (e.g. cyclohexanone). Dilution with water gives a dispersion.

iii) Emulsifiable Concentrates (EC)

20 15-70 wt % of the pesticidal active compound(s), and 5-10 wt % emulsifiers (e.g. calcium dodecylbenzenesulfonate and castor oil ethoxylate) are dissolved in up to 100 wt % water-insoluble organic solvent (e.g. aromatic hydrocarbon). Dilution with water gives an emulsion.

iv) Emulsions (EW, EO, ES)

5-40 wt % of the pesticidal active compound(s), and 1-10 wt % emulsifiers (e.g. calcium dodecylbenzenesulfonate and castor oil ethoxylate) are dissolved in 20-40 wt % water-insoluble organic solvent (e.g. aromatic hydrocarbon). This mixture is introduced into up to 100 wt % water by means of an emulsifying machine and made into a homogeneous emulsion. Dilution with water gives an emulsion.

v) Suspensions (SC, OD, FS)

In an agitated ball mill, 20-60 wt % of the pesticidal active compound(s), are comminuted with addition of 2-10 wt % dispersants and wetting agents (e.g. sodium lignosulfonate and alcohol ethoxylate), 0, 1-2 wt % thickener (e.g. xanthan gum) and up to 100 wt % water to give a fine active substance suspension. Dilution with water gives a stable suspension of the active substance. For FS type composition up to 40 wt % binder (e.g. polyvinylalcohol) is added.

vi) Water-Dispersible Granules and Water-Soluble Granules (WG, SG)

50-80 wt % of the pesticidal active compound(s), are ground finely with addition of up to 100 wt % dispersants and wetting agents (e.g. sodium lignosulfonate and alcohol ethoxylate) and prepared as water-dispersible or water-soluble granules by means of technical appliances (e. g. extrusion, spray tower, fluidized bed). Dilution with water gives a stable dispersion or solution of the active substance.

vii) Water-Dispersible Powders and Water-Soluble Powders (WP, SP, WS)

50-80 wt % of the pesticidal active compound(s), are ground in a rotor-stator mill with ad-dition of 1-5 wt % dispersants (e.g. sodium lignosulfonate), 1-3 wt % wetting agents (e.g. alcohol ethoxylate) and up to 100 wt % solid carrier, e.g. silica gel. Dilution with water gives a stable dis-persion or solution of the active substance.

viii) Gel (GW, GF)

In an agitated ball mill, 5-25 wt % of the pesticidal active compound(s), are comminuted with addition of 3-10 wt % dispersants (e.g. sodium lignosulfonate), 1-5 wt % thickener (e.g. carboxymethylcellulose) and up to 100 wt % water to give a fine suspension of the active substance. Dilution with water gives a stable suspension of the active substance.

ix) Microemulsion (ME)

5-20 wt % of the pesticidal active compound(s), are added to 5-30 wt % organic solvent blend (e.g. fatty acid dimethylamide and cyclohexanone), 10-25 wt % surfactant blend (e.g. alkohol ethoxylate and arylphenol ethoxylate), and water up to 100%. This mixture is stirred for 1 h to produce spontaneously a thermodynamically stable microemulsion.

x) Microcapsules (CS)

An oil phase comprising 5-50 wt % of the pesticidal active compound(s), 0-40 wt % water insoluble organic solvent (e.g. aromatic hydrocarbon), 2-15 wt % acrylic monomers (e.g. methylmethacrylate, methacrylic acid and a di- or triacrylate) are dispersed into an aqueous solution of a protective colloid (e.g. polyvinyl alcohol). Radical polymerization initiated by a radical initiator results in the formation of poly(meth)acrylate microcapsules. Alternatively, an oil phase comprising 5-50 wt % of the pesticidal active compound(s), 0-40 wt % water insoluble organic solvent (e.g. aromatic hydrocarbon), and an isocyanate monomer (e.g. diphenylme-thene-4,4′-diisocyanatae) are dispersed into an aqueous solution of a protective colloid (e.g. polyvinyl alcohol). The addition of a polyamine (e.g. hexamethylenediamine) results in the for-mation of a polyurea microcapsule. The monomers amount to 1-10 wt %. The wt % relate to the total CS composition.

xi) Dustable Powders (DP, DS)

1-10 wt % of pesticidal active compound(s), are ground finely and mixed intimately with up to 100 wt % solid carrier, e.g. finely divided kaolin.

xii) Granules (GR, FG)

0.5-30 wt % of v, is ground finely and associated with up to 100 wt % solid carrier (e.g. silicate). Granulation is achieved by extrusion, spray-drying or the fluidized bed.

xiii) Ultra-Low Volume Liquids (UL)

1-50 wt % of pesticidal active compound(s), are dissolved in up to 100 wt % organic solvent, e.g. aromatic hydrocarbon.

The compositions types i) to xi) may optionally comprise further auxiliaries, such as 0.1-1 wt % bactericides, 5-15 wt % anti-freezing agents, 0.1-1 wt % anti-foaming agents, and 0.1-1 wt % colorants.

The agrochemical compositions generally comprise between 0.01 and 95%, preferably between 0.1 and 90%, and most preferably between 0.5 and 75%, by weight of active substance. The active substances are employed in a purity of from 90% to 100%, preferably from 95% to 100% (according to NMR spectrum).

Various types of oils, wetters, adjuvants, fertilizer, or micronutrients, and other pesticides (e.g. herbicides, insecticides, fungicides, growth regulators, safeners) may be added to the active substances or the compositions com a prising them as premix or, if appropriate not until immediately prior to use (tank mix). These agents can be admixed with the compositions according to the invention in a weight ratio of 1:100 to 100:1, preferably 1:10 to 10:1

The user applies the composition according to the invention usually from a predosage de-vice, a knapsack sprayer, a spray tank, a spray plane, or an irrigation system. Usually, the agrochemical composition is made up with water, buffer, and/or further auxiliaries to the desired application concentration and the ready-to-use spray liquor or the agrochemical composition according to the invention is thus obtained. Usually, 20 to 2000 liters, preferably 50 to 400 liters, of the ready-to-use spray liquor are applied per hectare of agricultural useful area.

According to one embodiment, individual components of the composition according to the invention such as parts of a kit or parts of a binary or ternary mixture may be mixed by the user himself in a spray tank and further auxiliaries may be added, if appropriate.

In a further embodiment, either individual components of the composition according to the invention or partially premixed components, e.g. components comprising pesticidal active compound(s), may be mixed by the user in a spray tank and further auxiliaries and additives may be added, if appropriate.

In a further embodiment, either individual components of the composition according to the invention or partially premixed components, e. g. components comprising pesticidal active compound(s), can be applied jointly (e.g. after tank mix) or consecutively.

Conventional seed treatment formulations include for example flowable concentrates FS, solutions LS, suspoemulsions (SE), powders for dry treatment DS, water dispersible powders for slurry treatment WS, water-soluble powders SS and emulsion ES and EC and gel formulation GF. These formulations can be applied to the seed diluted or undiluted. Application to the seeds is carried out before sowing, either directly on the seeds or after having pregerminated the latter. Preferably, the formulations are applied such that germination is not included.

The active substance concentrations in ready-to-use formulations, which may be obtained after two-to-tenfold dilution, are preferably from 0.01 to 60% by weight, more preferably from 0.1 to 40% by weight.

In a preferred embodiment, a FS formulation is used for seed treatment. Typically, a FS formulation may comprise 1-800 g/l of active ingredient, 1-200 g/I Surfactant, 0 to 200 g/I antifreezing agent, 0 to 400 g/l of binder, 0 to 200 g/l of a pigment and up to 1 liter of a solvent, preferably water.

Especially preferred FS formulations of the compound I, preferably compound i) of formula (I), for seed treatment usually comprise from 0.1 to 80% by weight (1 to 800 g/l) of the active ingredient, from 0.1 to 20% by weight (1 to 200 g/l) of at least one surfactant, e.g. 0.05 to 5% by weight of a wetter and from 0.5 to 15% by weight of a dispersing agent, up to 20% by weight, e.g. from 5 to 20% of an anti-freeze agent, from 0 to 15% by weight, e.g. 1 to 15% by weight of a pigment and/or a dye, from 0 to 40% by weight, e.g. 1 to 40% by weight of a binder (sticker/adhesion agent), optionally up to 5% by weight, e.g. from 0.1 to 5% by weight of a thickener, optionally from 0.1 to 2% of an anti-foam agent, and optionally a preservative such as a biocide, antioxidant or the like, e.g. in an amount from 0.01 to 1% by weight and a filler/vehicle up to 100% by weight.

In the treatment of seed, the application rates of the carboxamide compound i) of formula (I), of the carboxamide compound ii) of formula (Ia) or of a mixture comprising the carboxamide compounds i) and ii), are generally from 0.1 g to 10 kg per 100 kg of seed, preferably from 1 g to 5 kg per 100 kg of seed, more preferably from 1 g to 1000 g per 100 kg of seed and in particular from 1 g to 200 g per 100 kg of seed, e.g. from 1 g to 100 g or from 5 g to 100 g per 100 kg of seed.

The invention therefore also relates to seed comprising comprising at least one of compound of formula (Ia), (Ib) or mixture comprising the compound of formula (Ia) and the compound of formula (Ib). The amount of the comprising at least one of compound of formula (Ia), (Ib) or mixture comprising the compound of formula (Ia) and the compound of formula (Ib) will in general vary from 0.001 g to 10 kg per 100 kg of seed, preferably 0.1 g to 10 kg per 100 kg of seed, more preferably from 1 g to 5 kg per 100 kg of seed, in particular from 1 g to 1000 g per 100 kg of seed. For specific crops such as lettuce the rate can be higher. In particular, the invention relates to the seed, comprising at least one of the compound of formula (Ia), (Ib) or mixture comprising the compound of formula (Ia) and the compound of formula (Ib) in an amount of from 0.001 g to 100 g of at least one of the compound of formula (Ia), (Ib) or mixture comprising the compound of formula (Ia) and the compound of formula (Ib) per 100 kg of seed. More particularly, 5 g to 100 g of at least one of the compound of formula (Ia), (Ib) or mixture comprising the compound of formula (Ia) and the compound of formula (Ib) per 100 kg of seed.

### EXAMPLES

Watering cycles—The level of stress is created by watering the pots based on the % of pot moisture as measured by wireless probes. Depending on weather conditions the number of cycles vary as needed.

The % of moisture triggers the watering process independent of the time that it takes to reach this point.

In “well-watered conditions” or “standard watered conditions”, in pots the % moisture is kept above 80%.

In “drought conditions”, in the pots re-watering happens at 45% pot moisture.

“Untreated” means that the seed has not been exposed to the compound I (a).

The treaments(s) were applied directly over the planted seed at the rates found in the table(s) below. Seeds were then covered and the % rate of germination was calculated at 21 days after planting.

The % rate of germination was calculated as the number of seeds that emerged divided by the number of seeds planted and presented as as a percentage.

Seeds were planted in two types of soil (Mineral and Organic) which were free of pest (insects, weeds, or diseases) to avoid interactions with the treatments applied

### Example 1: Increase in % of Germination in Maize (Corn) by Drench Treatment

| | | 0.5 mg of | 1 mg of |
|---|---|---|---|
| Treatments | Untreated | (la)*/plant | (la)*/plant |
| % Germination in Mineral soil in | 95 | 100 | 100 |
| Standard conditions | | | |
| % Germination in Organic soil in | 95 | 98 | 100 |
| Draught conditions | | | |

### Example 2: Increase % Germination in Wheat by Seed Treatement

| | | 0.5 mg of |
|---|---|---|
| Treatments | Untreated | (la)*/plant |
| % Germination in Mineral soil in | 89 | 95 |
| Standard conditions | | |
| % Germination in Organic soil in | 86 | 95 |
| Draught conditions | | |
| % Germination in Organic soil in | 89 | 100 |
| Standard conditions | | |

*30% FS formulation

1. A method for increasing the resistance of a cereal plant selected from the group consisting of wheat and corn, and/or its plant propagation material, to abiotic stress comprising treating the cereal plant selected from the group consisting of wheat and corn and/or its plant propagation material with at least one of
i) compound of formula (Ia), 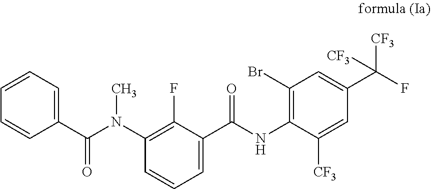 [SMILES: CN(C(=O)c1ccccc1)c1cccc(C(=O)Nc2c(Br)cc(C(F)(C(F)(F)F)C(F)(F)F)cc2C(F)(F)F)c1F]
ii) compound of formula (Ib), or 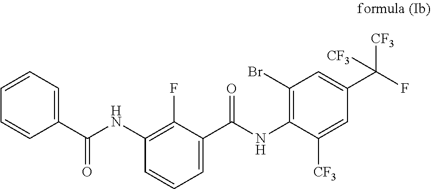 [SMILES: O=C(Nc1cccc(C(=O)Nc2c(Br)cc(C(F)(C(F)(F)F)C(F)(F)F)cc2C(F)(F)F)c1F)c1ccccc1]
iii) mixture comprising the compound of formula (Ia) and the compound of formula (Ib), or an acceptable salt, stereoisomers, an isotopic form, or N-oxide.

2. The method of claim 1, comprising applying directly and/or indirectly to the cereal plant selected from the group consisting of wheat and corn and/or its plant propagation material by drenching the soil, by drip application onto the soil, by soil injection, by dipping or by treatment of seeds or in-furrow, a composition comprising at least one of compound of formula (Ia), (Ib), or mixture comprising the compound of formula (Ia) and the compound of formula (Ib) or an acceptable salt, stereoisomers, an isotopic form, or N-oxide.

3. The method of claim 2, comprising applying directly and/or indirectly to the cereal plant selected from the group consisting of wheat and corn and/or its plant propagation material by drenching the soil, a composition comprising at least one of compound of formula (Ia), (Ib), or mixture comprising the compound of formula (Ia) and the compound of formula (Ib) or an acceptable salt, stereoisomers, an isotopic form, or N-oxide.

4. The method according to claim 2, wherein the composition comprises at least one of compound of formula (Ia), (Ib), or mixture comprising the compound of formula (Ia) and the compound of formula (Ib) or an acceptable salt, stereoisomers, an isotopic form, or N-oxide and/or a liquid or a solid carrier.

5. The method according to claim 1, wherein the cereal plant and/or its plant propagation material is selected each in its natural or genetically modified form.

6. The method according to claim 1, wherein the increased resistance is determined by an increased rate of germination of cereal seed selected from the group consisting of wheat and corn and/or emergence and/or increasing height of cereal plant selected from the group consisting of wheat and corn and/or increasing root length of cereal plant selected from the group consisting of wheat and corn as compared to the cereal plant selected from the group consisting of wheat and corn and/or its plant propagation material not contacted with at least one of the compound of formula (Ia), (Ib), or mixture comprising the compound of formula (Ia) and the compound of formula (Ib) or an acceptable salt, stereoisomers, an isotopic form or N-oxide, in both well watered or standard watered and drought conditions.

7. The method according to claim 1, wherein the increased resistance is determined by the increased rate of germination of cereal seed selected from the group consisting of wheat and corn.

8. The method according to claim 1, wherein the increased resistance is determined by an increased drought resistance of the cereal plant selected from the group consisting of wheat and corn and/or its plant propagation material as compared to the a drought stress resistance of the cereal plant selected from the group consisting of wheat and corn and/or its plant propagation material not contacted with at least one of the compound of formula (Ia), (Ib) or mixture comprising the compound of formula (Ia) and the compound of formula (Ib), or an acceptable salt, stereoisomers, an isotopic form, or N-oxide.

9. The method according to claim 1, wherein the increased resistance is determined by increased water uptake in the cereal plant selected from the group consisting of wheat and corn and/or its plant propagation material as compared to a water uptake of the cereal plant selected from the group consisting of wheat and corn and/or its plant propagation material not contacted with at least one of the compound of formula (Ia), (Ib), or mixture comprising the compound of formula (Ia) and the compound of formula (Ib) or an acceptable salt, stereoisomers, an isotopic form, or N-oxide, in drought conditions.

10. The method according to claim 1, comprising applying directly and/or indirectly to the cereal plant selected from the group consisting of wheat and corn and/or its plant propagation an amount of from 0.0001 g to 100 g of at least one of the compound of formula (Ia), (Ib), or mixture comprising the compound of formula (Ia) and the compound of formula (Ib) or an acceptable salt, stereoisomers, an isotopic form, or N-oxide.

11. The method according to claim 1, comprising treating the cereal seed selected from the group consisting of wheat and corn with an amount from 0.001 g to 100 g of at least one of the compound of formula (Ia), (Ib), or mixture comprising the compound of formula (Ia) and the compound of formula (Ib) or an acceptable salt, stereoisomers, an isotopic form, or N-oxide per 100 kg of seed.

12. The method according to claim 1, wherein the increased resistance of the cereal plant selected from the group consisting of wheat and corn and/or its plant propagation material is determined by an improved yield as compared to a yield of the cereal plant selected from the group consisting of wheat and corn and/or its plant propagation material not contacted with at least one of the compound of formula (Ia), (Ib), or mixture comprising the compound of formula (Ia) and the compound of formula (Ib) or an acceptable salt, stereoisomers, an isotopic form, or N-oxide, in both well watered or standard watered and drought conditions.

13. The method according to claim 1, wherein the selected one or more increased resistance cereal plant selected from the group consisting of wheat and corn and/or its plant propagation material is further selected for having increased rate of germination of cereal seed selected from the group consisting of wheat and corn and/or emergence and/or increasing height of cereal plant selected from the group consisting of wheat and corn and/or increasing root length of cereal plant selected from the group consisting of wheat and corn and/or increased water uptake and/or an increased drought resistance relative to cereal plant selected from the group consisting of wheat and corn and/or its plant propagation material not contacted with at least one of the compound of formula (Ia), (Ib), or mixture comprising the compound of formula (Ia) and the compound of formula (Ib) or an acceptable salt, stereoisomers, an isotopic form or N-oxide, in both well watered or standard watered and drought conditions.

14. The method according to claim 1, wherein the cereal plant selected from the group consisting of wheat and corn and/or its plant propagation material is in the crop production field.

15. A cereal seed selected from the group consisting of wheat seed and corn seed, comprising at least one of the compound of formula (Ia), (Ib), or mixture comprising the compound of formula (Ia) and the compound of formula (Ib) or an acceptable salt, stereoisomers, an isotopic form, or N-oxide, as defined in claim 1 in an amount of from 0.001 g to 1000 g of at least one of the compound of formula (Ia), (Ib) or mixture comprising the compound of formula (Ia) and the compound of formula (Ib) or an acceptable salt, stereoisomers, an isotopic form or N-oxide, per 100 kg of seed.
